(19) United States
(12) Patent Application Publication
(10) Pub. No.: US 2006/0223496 A1
(43) Pub. Date: Oct. 5, 2006

(54) System and method for detection of mobile handset software corruption

(75) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/095,380

(22) Filed: Mar. 31, 2005

(51) Int. Cl. H04M 1/66; H04M 1/68

(52) U.S. Cl. 455/410

(57) ABSTRACT

A system and method for detecting wireless telecommunications mobile handset software corruption is provided. The method includes retrieving stored configuration data and stored checksum for a mobile handset stored on a wireless telecommunications network element, determining an actual checksum from the mobile handset, comparing the actual mobile handset checksum with the stored checksum retrieved from the network element, and detecting a mobile handset software corruption. Uncorrupted software can then be downloaded to the mobile handset thereby repairing the software corruption.

### BACKGROUND OF THE INVENTION

This invention relates to a mobile handsets and more particularly to detecting mobile handset software corruption.

Wireless telecommunication networks enable a person to communicate with others while moving about using a mobile handset, also referred to a cellular phone. As a result of technological improvements, mobile handsets are providing more and more services and features. The computing power of these handsets increases along with the complexity and sophistication of their software. Mobile handsets can access the Internet via the telecommunications network and download software providing even more services and features. However, this access to software outside the control of the wireless telecommunication provider presents problems.

As in the case of desktop and laptop computers, mobile handsets are becoming vulnerable to “worms” and other virus-like software corruption. Capabilities put in place for the convenience of the handset user can be subverted by corrupted software to work against the user. For example viruses are now capable of erasing or even stealing a subscriber's telephone directory stored in the memory of a mobile handset.

The need exists for an efficient method of detecting mobile handset software corruption and repairing corrupted software upon detection. The present invention contemplates a new and improved system and method that resolves these problems and others.

### SUMMARY OF THE INVENTION

A system and method for detecting wireless telecommunications mobile handset software corruption is provided.

In one aspect of the invention, the method can include retrieving stored configuration data and stored checksum for a mobile handset stored on a wireless telecommunications network element, determining an actual checksum from the mobile handset, comparing the actual mobile handset checksum with the stored checksum retrieved from the network element, and detecting a mobile handset software corruption.

In another aspect of the invention, the method can also include downloading uncorrupted software to the mobile handset effectively repairing the software corruption.

In another aspect of the invention, the system includes means for retrieving configuration data and checksum for a mobile handset saved on a wireless telecommunications network element, means for determining a checksum from the mobile handset, means for comparing the mobile handset checksum with the checksum retrieved from the network element, and means for detecting a mobile handset software corruption.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a communications network including a system for practicing aspects of the present inventive subject matter;

FIG. 2 is a flow chart illustrating a method in accordance with the present invention; and

FIG. 3 is a call flow diagram illustrating messages and data sent in accordance with the present invention.

### DETAILED DESCRIPTION OF THE PREFERRED EMBODIMENTS

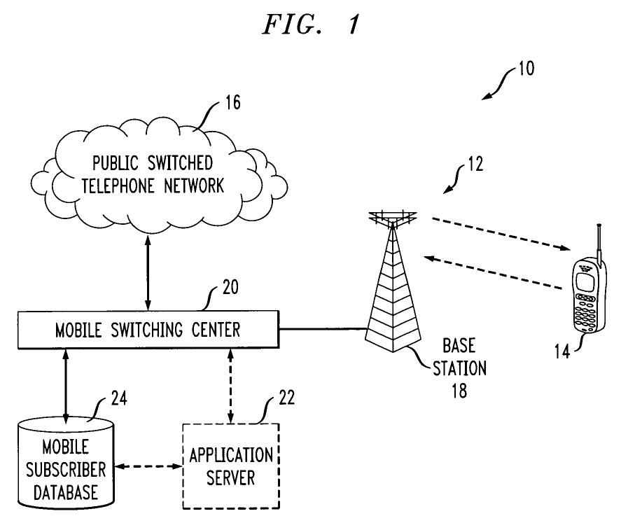

Referring now to the drawings wherein the showings are for purposes of illustrating the preferred embodiments of the invention only and not for purposes of limiting same, FIG. 1 provides a view of the overall preferred system according to the present invention.

As shown in FIG. 1, a system for detecting and/or repairing software corruption on one or more mobile handsets is shown generally at 10. A portion of a telecommunications network is shown generally at 12 for providing wireless communications to a mobile subscriber's mobile handset 14, also known as a cellular handset. The mobile subscriber's handset 14 can communicate with other handsets (not shown) including, but not limited to, other mobile handsets, landline handsets, also known as Plain Old Telephone Service telephones, or other phones capable of communicating over the Public Switched Telephone Network shown generally at 16.

A Base Station 18 provides over-the-air communications between the mobile handset 14 and the wireless telecommunications network 12. A Mobile Switching Center (MSC) 20 is responsible for routing calls to and from the mobile handset 14, including calls from the PSTN 16. The MSC also handles call set-ups for the mobile handset. The MSC 20 can also provide services and features to the mobile handset 14 such as voice mail, call waiting, caller ID, and others which can be made available via subscription. Unless stated otherwise, the MSC 20 can perform the functions described herein for detecting and/or repairing a mobile handset software corruption. However, it should be appreciated that these functions may be performed by another telecommunications network element, such as an Application Server shown in dashed lines at 22, disposed apart from and connected to the MSC 20 in a known manner.

A mobile Subscriber Database 24 is connected to the MSC 20 in a known manner. The Subscriber Database 24 includes subscriber information which can include the calling services and features the subscriber has subscribed to. The task of detecting and/or repairing a mobile handset software corruption, as described herein, can be made available as a feature for subscribers. Thus, the MSC 20 can check with the Subscriber Database 24 to verify that this feature is available to the subscriber as described below.

The subscriber's handset 14 is associated with the subscriber in the Subscriber Database. Configuration parameters for the handset are also stored in the Subscriber Database 24 and associated with the subscriber for access by the MSC 20 and/or Application Server 22. The handset configuration parameters are used to determine the handset software running on the mobile handset. The handset configuration parameters can include, but are not limited to, the Electronic Serial Number (ESN) of the handset, the manufacturer of the handset, the handset model number, and software identifiers identifying the software that was installed on mobile handset. The software identifiers can identify software that the telecommunications provider initially installed on the handset. The software identifiers can be updated on a periodic basis as desired. The stored handset configuration parameters also include one or more stored checksum(s), derived in a manner as described below, from the handset at a time when it was known that the handset did not contain a software corruption.

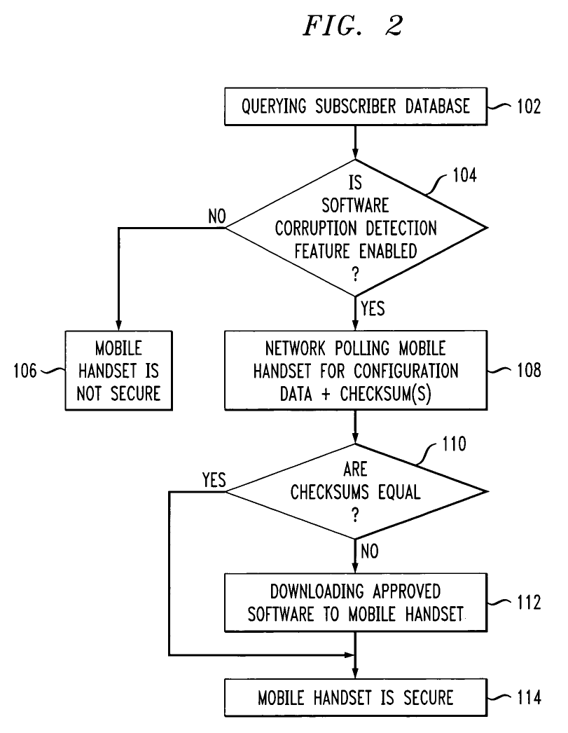

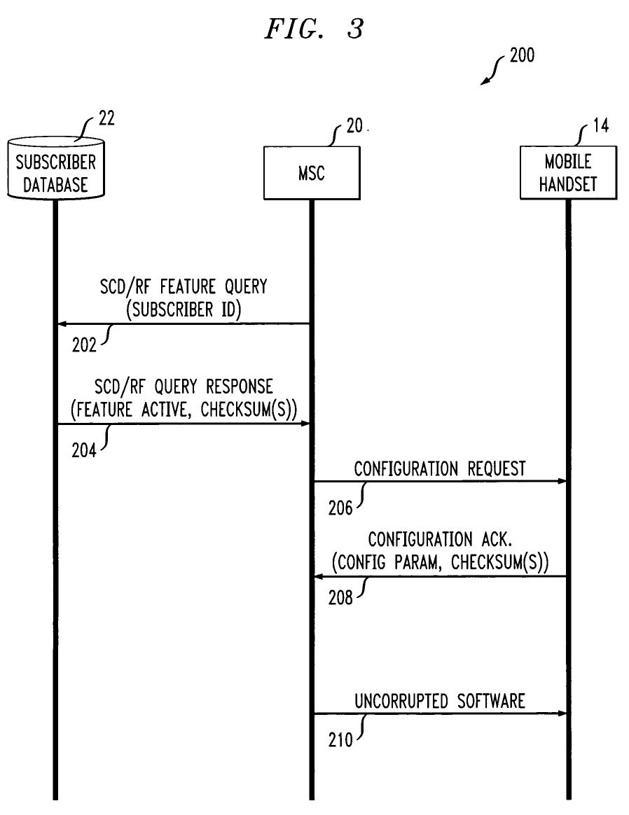

Referring now to FIGS. 2 and 3, the method of operation of the system for detecting mobile handset software corruption shown generally at 100 shall now be described. For simplicity, the operation shall be described with reference to a single mobile handset 12, although it should be appreciated that the invention can detect and/or repair software corruption on any number of mobile handsets.

The MSC 20 queries the Subscriber Database at 102 to determine if the handset software corruption detection/repair feature is available to the subscriber, also referred to as being enabled, at 104. This feature can be made available to the subscriber for a subscription fee, or as part of a feature package which may include usage of the wireless network 12. Further, the subscriber may choose to disable it. The query, referred to generally as a Software Corruption Detection/Repair Feature (SCD/RF) Query shown at 202 in FIG. 3, includes a subscriber identifier. The Subscriber Database 24 uses the subscriber identifier to access the subscriber information indicating whether or not the feature is available. A SCD/RF Query Response is returned from the Subscriber Database 22 to the MSC 20 as shown at 204. If the feature is available, the SCD/RF Query Response includes an indicator indicating the feature is available. The SCD/RF Query Response also includes the stored checksum(s) for the handset.

If it is determined that the handset software corruption detection/repair feature is not enabled at 104, the mobile handset 14 may be considered to be not secure against software corruption. Alternatively, if the virus detection/repair feature is found to be enabled at 104, the MSC 20, or Application Server 22, polls the mobile handset for software configuration data and a checksum at 108. As shown at 206 the MSC 20 sends a Configuration Request message to the mobile handset asking for the handset's configuration parameters and checksum. The mobile handset responds to the Configuration Request 206 by sending a Configuration Acknowledgement back to the MSC as shown at 208. The Configuration Acknowledgement 208 includes the handset's software configuration parameters and one or more of the handset's current checksum(s).

The current checksum(s) are generated by performing a mathematical operation on all the data on the handset 14. The current checksum(s) provide a unique representation of a handset's file bit sequences. The current checksum(s) can include one or more checksums. An algorithm is used that reads files' bytes sequentially, essentially creating a unique numeric code, the checksum(s), that represents the files. The checksum(s) will change according to the value of the data on the handset 14 and any subsequent change to the files will produce a change in the checksum(s) calculation. The mobile handset 14 derives its current checksum(s) and transfers it back to the MSC 20 or Application Server 22 in the Configuration Acknowledgement 208.

The checksums, including the checksum(s) stored on the Subscriber Database and obtained in step 104, and the current checksum(s) for the handset returned in the polling step of 108 are then compared to see if they are equal at 110. The checksum comparison, comparing the mobile handset's current checksum(s) to the stored checksum(s) recorded when the mobile handset was in a known, clean state can be used to determine that the mobile handset software is corrupted. Comparing two checksums of the same files at different times can flag file changes caused by a virus or other software corruption.

If the checksums are equal, the handset software has not been corrupted and the mobile handset can be considered to be secure at 114. Software corruption, such as viruses or other malicious code typically makes a modification to the system software in order to infect it. For example, a virus typically modifies a file by overwriting or adding its code to the file, so that when the file is run the corrupted code is run as well. If the checksums are not determined to be equal at 110, the handset software can be determined to be corrupted.

The MSC 20 can effectively repair the software corruption by downloading corruption free software to the handset 14 over-the-air via the base station 18. The MSC 20 can notify the subscriber that corrupted software was discovered on the subscriber's handset and prompt them subscriber to download uncorrupted software. Alternatively, this can be done automatically.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of detecting a wireless telecommunications mobile handset software corruption comprising:
retrieving stored configuration data and stored checksum for a mobile handset stored on a wireless telecommunications network element;
determining an actual checksum from the mobile handset;
comparing the actual mobile handset checksum with the stored checksum retrieved from the network element; and
detecting a mobile handset software corruption.

2. The method defined in claim 1 wherein the detecting step further comprises determining that the actual mobile handset checksum and the stored checksum compared in the comparing step are not equal.

3. The method defined in claim 2 further comprising downloading uncorrupted mobile handset software from a wireless telecommunications network element onto the mobile handset.

4. The method defined in claim 3 further comprising using the stored configuration parameters to determine the uncorrupted mobile handset software to download in the downloading step.

5. The method defined in claim 1 wherein the step of determining an actual checksum from the mobile handset further comprises receiving the actual checksum transmitted by the mobile handset over the wireless telecommunications network.

6. The method defined in claim 1 wherein the step of retrieving stored configuration data further comprises retrieving at least one of the handset manufacturer, the handset model number, and the Mobile Protocol Revision Level.

7. A method of repairing a wireless telecommunications mobile handset software corruption comprising:
retrieving configuration data and checksum for a mobile handset saved on a wireless telecommunications network element;
determining a checksum from the mobile handset;
comparing the mobile handset checksum with the checksum retrieved from the network element; and
detecting a mobile handset software corruption.

8. The method defined in claim 7 wherein the detecting step further comprises determining that the mobile handset checksum and the retrieved checksum compared in the comparing step are not equal.

9. The method defined in claim 8 further comprising downloading uncorrupted mobile handset software from a wireless telecommunications network element onto the mobile handset.

10. The method defined in claim 9 further comprising using the stored configuration parameters to determine the uncorrupted mobile handset software to download in the downloading step.

11. The system defined in claim 7 wherein the step of determining a checksum from the mobile handset further comprises receiving the checksum transmitted by the mobile handset over the wireless telecommunications network.

12. A system for detecting a mobile handset software corruption comprising:
means for retrieving configuration data and checksum for a mobile handset saved on a wireless telecommunications network element;
means for determining a checksum from the mobile handset;
means for comparing the mobile handset checksum with the checksum retrieved from the network element; and
means for detecting a mobile handset software corruption.

13. The system defined in claim 12 wherein the means for detecting further comprises means for determining that the mobile handset checksum and the retrieved checksum are not equal.

14. The system defined in claim 13 further comprising means for downloading uncorrupted mobile handset software from a wireless telecommunications network element onto the mobile handset.

15. The system defined in claim 12 further comprising means for receiving the checksum transmitted by the mobile handset over the wireless telecommunications network.
